(19) United States
(12) Patent Application Publication
(10) Pub. No.: US 2005/0033595 A1
(43) Pub. Date: Feb. 10, 2005

(54) System for performing electronic transactions and a process to send instructions

(76) Inventor: Mauricio Luiz Bonini, Sao Paulo (BR)

Correspondence Address: KENYON & KENYON, ONE BROADWAY, NEW YORK, NY, 10004, US

(21) Appl. No.: 10/862,922

(22) Filed: Jun. 7, 2004

(30) Foreign Application Priority Data
Jun. 5, 2003 (BR) PI0301742-7

(51) Int. Cl. G06F 17/60

(52) U.S. Cl. 705/1

(57) ABSTRACT

A system and method for performing electronic business is disclosed. At least one remote terminal that may be communicatively coupled to at least one managing device and may have a program including at least one first instruction for operation of the at least one terminal, may capture data for a transaction that may be routed towards the at least one managing device, information may be analyzed on the at least one managing device, the at least one managing device may respond to the at least one terminal either confirming or not confirming the transaction, and the at least one managing device may send towards the at least one terminal at least one second instruction for operation of the at least one terminal.

### RELATED APPLICATION INFORMATION

This application claims, under 35 U.S.C. § 119, priority to and the benefit of Brazilian patent application no. P10301742-7, filed on Jun. 5, 2003, the entirety of which is incorporated herein by reference thereto.

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

Conventionally, a system for performing electronic business (called “transactions” herein), e.g., financial business, such as those transactions between a consumer and a trading company via use of debit and/or credit cards, includes at least a remote terminal for capturing data, e.g., a point of sale device (POS), provided with peripherals. Conventionally, the remote terminals are connected through a data communication network to an intermediate servicing device which concentrates and converts the transactions by sending the transactions to a central processing device which deals with pre-validation and routing of the transactions for transaction authorization systems.

Such a system for performing electronic transactions can also apply to transactions that do not involve magnetic cards, such as reloading of cellular phone, bill and taxes payment, lottery and so on.

The terminal is managed by management programs, such as command sub-routines contained inside the terminal. The management program may capture information and code the information in a suitable alpha-numerical format for electronic transmission.

In those systems that operate with magnetic cards, e.g., credit cards, the captured information corresponds to data found in the magnetic card. Data found in the magnetic card may include, but is not limited to: (i) information regarding the card number, validity date, and the like, that can be acquired via magnetic reading or manual input (typing); (ii) personal information of the consumer, e.g., a password, required for the accomplishment of certain types of transactions; or (iii) information of the trading company.

In those systems that do not operate with magnetic cards, e.g., systems where payment is made with cash, data is entered in the system in another manner, e.g., by keying, among others.

Whatever the manner to enter transaction data (magnetic card or other), the command sub-routines may be divided into three layers, namely:
first layer: deals with the control of the components, electronic devices and peripherals as well as the interface of these devices with the commands of the second layer;
second layer: deals with interpreters that both decode the instructions and control performance of the instructions through sequential activation of the corresponding functions in the first layer; and
third layer: named application, deals with the implementation of the functionality and the specific tasks available in every terminal.

Generally, when the terminal is activated, the first layer performs automatic test operations on the electronic devices and activates the second layer to interpret the initial page of the application, thus setting the terminal in a stand-by state with respect to external events.

When a user runs the magnetic card along the reader slot or inputs any data by typing on the keyboard, such events are captured by the first layer, formatted and re-passed on to the second layer, wherein the sequence of commands specified in the third layer is processed, which guides the input data by sending messages to the monitor, thus gathering and formatting the captured information in alpha-numerical commands by the end of the procedure so that they can be sent through the communication network.

The response to the transaction (e.g., acceptance, rejection or request for the input of other data) is disencapsulated in the first layer and sent to the second layer wherein it is decoded, and the result is shown via a printer, a keyboard, an audio signal, or a combination of same.

Usually, a system for performing electronic transactions includes a plurality of the terminals indistinctly connected to the access network.

Despite the fact that this system is very efficient, when the conventional transactions based on paper currency or paper credit bonds (checks) are replaced, there may be a number of drawbacks (to be described below) related to the constant need to update the procedures and routines to be developed for each of the terminals that make out same.

In this sense, when, for example, a system operated by a credit card administrating company, or a cellular telephony services operator company that operates throughout the country is contemplated, there may be a need to update thousands of remote terminals all over the country, thus increasing the drawbacks considerably. The result is that the costs for the operation of the system are raised.

The constant update of the procedures and routines to be carried out for the terminals is required in order that the system for performing financial transactions may go on operating. As an example of such changes, reference can be made to the need of typing the four last numbers of a magnetic card, without which the terminal does not perform the transaction, a procedure not required until very recently. As an additional example, in the case of reloading of cellular phones credits, there may be variation as to the frequent promotions that often change the available value for reloading.

Presently, the changes have to be individually inserted in each of the existing terminals, since the remote update of the terminals blocked their capacity to perform transactions, displeasing the traders and consumers who therefore, once in a while, could not have done transactions electronically.

Currently, however, personnel of a company that operates these systems must directly update the command sub-routines in each of the terminals. Therefore, a great number of personnel who move around throughout the area in which the system is operated, which may be a vast area, is required to update the system.

That a great number of personnel is required results in a great delay when updating all the terminals of the system. Also, it makes operation of the system more expensive, in view of the high expenses spent for the required personnel, time and fuel for such an update.

Even worse, where the changes/updates constantly take place, e.g., because of economical/social needs of a country, the system update operates intermittently, in such way that such high expenses considerably and constantly influence the operational cost of the system. Therefore, the operational cost many times must be shared, at least in part, with the traders who own remote terminals in their trading sites.

Therefore, when the system for capturing current financial transactions is used, the losers are (i) the traders, who must many times pay service administrating firms (credit card administrating companies, lottery, cellular telephony operator companies, etc.) a high rate to be able to use the system, (ii) the consumers of a number of commercial sites that do not use the system due to high rates, e.g., commercial sites of lower size, and (iii) the card administrating firm/operator companies of these services that possess a lesser number of users sites than they could, and that have tense commercial relations with such traders due to the high rates for using the system.

Up to now, a system for performing electronic transactions that makes it possible to remotely update terminals without requiring the presence of on-site personnel, and that does not stop or seriously compromise a terminal's ability to perform transactions during the update has not been proposed.

### BRIEF DESCRIPTION OF THE DRAWINGS

FIG. 1 is a block diagram that illustrates the components of an example operating scheme for performing electronic transactions, according to an example embodiment of the present invention.

### DETAILED DESCRIPTION OF EXAMPLE EMBODIMENTS

Example embodiments of the present invention provide a system for performing electronic transactions. The system may be provided with the functionality for remotely implementing new tasks and improvements in remote terminals thereof, e.g., updating command sub-routines of remote terminals, in order not to require the presence of skilled personnel to update the terminals individually.

Example embodiments of the present invention also provide a procedure for sending instructions, e.g., to be executed by a system for performing electronic transactions, bringing advantages to the users and operators.

In an example embodiment of the present invention, the system may include at least one terminal provided with at least one management program made up of at least one first instruction for operation of the terminal. The system may include at least one managing device. A terminal may be communicatively coupled to a managing device, in such a way that the managing device may selectively send towards the terminal at least one second instruction for the operation of the terminal.

Also, example embodiments of the present invention may include a procedure by which to send instructions, e.g., to be executed by a system for performing electronic business. The system may include at least one terminal that may be provided with at least one management program made up of at least one first instruction for the operation of the terminal, and that may be operatively coupled to at least one managing device. The procedure may include the following:
(i) data capture for a transaction on the terminal, plus organization and local storage thereof;
(ii) routing of the transaction to the managing device;
(iii) information analysis on the managing device;
(iv) response of the managing device to the terminal confirming or not the transaction.
   In (i) the managing device may be in communication with the terminal and may selectively send towards the terminal at least a second instruction for the operation of the terminal. Example embodiments of the present invention may include a system for performing electronic business that may make possible the remote update of the command sub-routines of the remote terminals, thus making it easy, fast and cheap to implement updates and/or further operations of the system. Example embodiments of the present invention may make it possible to attain a reduction in the cost of providing services of the system to potential traders and increasing it's the system's overall efficiency.

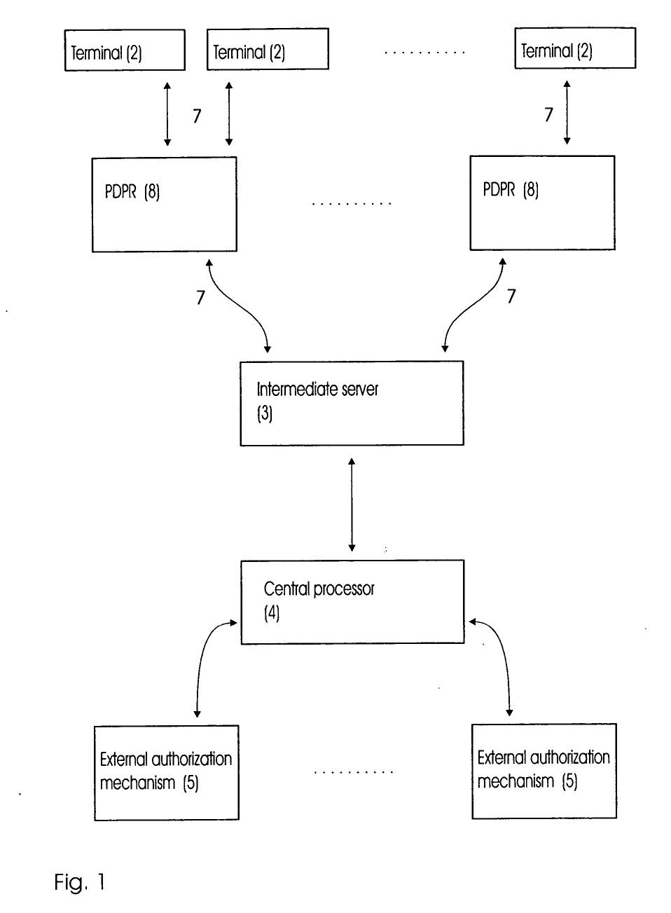

According to an example embodiment of the present invention, as illustrated in FIG. 1, a system for performing transactions may include at least one remote terminal 2, e.g., a plurality of remote terminals 2. Each terminal 2 may include peripherals for the input of data. Each terminal 2 may be connected to at least a first managing device, e.g., an intermediate server 3. Intermediate server 3 may concentrate and convert the transactions, and may send the transactions to at least a second managing device, e.g., a central processor 4. Central processor 4 may deal with pre-validation and routing of the transactions to external authorization mechanisms 5. The communication between these components may be carried out through a communication network 7 that will be described in more detail herein below.

The system may be particularly envisaged for performing electronic transactions, notably between a consumer and a trading company. The types of financial transactions executed, however, can vary, in such way that the system of the present invention can assume many variations, some of which are listed below, such as:
1. The system may be optimized to perform transactions by fixed data of magnetic cards, credit cards, bank debit cards or other types of cards (such as, for example, magnetic cards containing employees benefits) that can be viewed by the system;
2. The system may be optimized to perform transactions of reloading pre-paid cellular phone credits;
3. The system may, further, be optimized to make possible bill (compensation plug) and taxes payment, management and play of legalized games, e.g., lotteries, etc.

One can foresee many other types of electronic transactions to which the described embodiments can be applied

In order to execute payment, one may use a magnetic card that contains data that will be captured by the system or may use any other method of payment, e.g., cash.

In an embodiment where the system uses magnetic cards, a consumer may run a magnetic card along a slot of a remote terminal 2, e.g., for capture of data contained in the card. The data may include, e.g., a number, date of validity, etc. Input of additional information related to the transaction may be required, e.g., a monetary value, a number of payment, a code of a bill to be paid, a number of a pre-paid cellular phone to be reloaded, the four last numbers of a card, a user password, a validity date of a bill, a safety code of a cellular telephone, etc.

The remote terminal 2 may be configured in such a way that capture of data may be carried out in other ways, e.g., by use of a bar code, or by manual input (preferably via keying) into terminal 2, for example when a card does not provide for data capture.

In an embodiment where the system is intended to operate with cash, magnetic cards may not be used for data capture. Instead, information necessary for the transaction may be entered in other ways, e.g., keying.

The terminal 2 may also assume any other conventional configuration with respect to the input of data.

In an embodiment of the present invention, terminal 2 may include a keyboard for typing information, a monitor for showing guidelines and for exhibiting options and responses, and a reader for the capture of data. Terminal device 2 may use magnetic cards and the reader may be a card reader for reading magnetized tracks. The reader may also assume alternative configurations. For example, the reader may be configured as an optical reader of bar codes for reading the information printed in bar code format, as a CMC7 code to read checks, and the like. In addition, terminal 2 may include a modem or local network interface for the communication of data.

In an alternative embodiment of the present invention, transaction data may be entered without use of magnetic cards. Except for magnetic card related aspects of the configuration and functionality of terminal 2, the functionalities of terminal 2 according to the alternative embodiment may be for the most part identical to the functionalities of terminal 2 according to the previous embodiment.

Terminal 2 may be managed by a management program. The program may be a plurality of instructions for operation of terminal 2, in the form of command sub-routines. The command sub-routines may be concatenated and stored within terminal 2. The program may capture information necessary to realize the transaction (information contained in the card, data keying, etc.) and carry out the coding of the information in a format suitable for the information to be transmitted electronically. For example, the information may be alpha-numerically coded, or may be coded according to any other conventional method.

The command sub-routines of the terminal 1 disclosed herein may be divided into three layers, which are described in more detail herein below.

The first layer may deal with control of the components, electronic devices and peripherals as well as the interface of such devices with commands of the second layer (to be described herein below) through a definite set of operations called API (Advanced Program Interfaces), besides the implementation of the communication protocols, preferably in PPP (Point to Point Protocol) and TCP/IP (Transmission Control Protocol/Internet Protocol) standards designed to be used for the connection with communication networks, the transmission of the transactions and the subsequent reception of the responses. Of course the protocols used herein can vary, provided that they are functional when carrying out the communication of data.

The PPP protocol may be is used if the terminal 2/intermediate server 3 connection is dialed and the TCP/IP protocol may be used if the connection is a dedicated one.

The second layer may include interpreters for interpreting the instructions pages (to be described in more details herein below) of the WML (Wireless Markup Language) type and WML Script programs. The instruction pages may decode the commands in said standards (mentioned above in the description of the first layer), and for controlling the performance thereof through the sequential activation of the corresponding API's in the second layer.

The first and second layers can be generally named as first instruction to terminal operation, as explained herein below.

The third layer is called the application (or second instruction to the terminal operation, as explained below) and may include the WML architecture instructions pages and WML Script programs to be performed by the terminal 2, for dealing with the implementation of the functionality and the specific tasks available in every terminal.

The concatenated functioning of the first, second and third layers is described in more details herein below.

When the terminal 2 is activated, the first layer may execute the testing of automatic functions in the electronic devices and may activate the second layer to interpret the initial page of the application, thus placing the terminal 2 in a stand-by state related to the requests for transaction. Such requests may assume a number of forms, for an example running a card through a magnetic card reader, data keying, or the like, for starting the transaction.

Therefore, the electronic transaction may be started in terminal 2 wherein the data may be captured, at which time the keyboard, magnetic card reader, bar code reader, CMC-7 code reader, and the like, or a combination of such devices may be activated. The activation of such devices may generate events that may be captured and formatted by the first layer and passed on to the second layer. The second layer may process the events in accordance with the sequence of commands specified in the third layer, that simply will hereinafter be called application.

The application may guide the input of data into the remote terminal 2 by sending messages to the monitor, thus carrying out the reorganization and formatting of the information captured in WML alpha-numerical commands by the end of this procedure to send same through the communication network 7.

Before sending same, however, the second layer may pass the WML command on to the first layer, which may encapsulate same in a package in the format of a protocol (either of the PPP type if the connection is dialed or of the TCP/IP type if the connection is dedicated). The aim of the encapsulating procedure is to allow for the transmission and routing of the messages in networks that accept both PPP and TCP/IP standards, and also control information for protecting the integrity of the content of the messages.

The response to the transaction may also be received in the WML format encapsulated in PPP or TCP/IP protocols according to the type of connection. In the first layer, the response may be disencapsulated and the integrity thereof may be checked out. In the sequence, the response may be sent to the second layer that may decode and perform same through calls to the API's of the first layer for activating the printer, the monitor, or both.

In an example embodiment of the present invention, the system may include a plurality of terminals 2. In this embodiment, all of the terminals 2 may be indistinctly connected to the communication network 7.

The communication network 7 may be a set of data communication equipment of public and/or private use, linked through loops or data communication circuits in such a way that that remote terminals 2 which are geographically scattered can establish connections to a central processing site for exchanging information, which is the intermediate server 3 and the central processor 4.

In an embodiment of the present invention, the network 7 may be a hierarchical one. The network may present remote terminals 2 of one same region connected to a regional presence point or remote site 8, (hereinafter called PDPR), that locally concentrates the information received from the terminals 2 before sending same to the intermediate server 3/central processor 4.

There may be two main ways for connection with the communication network that may be used, the dialed connection or the dedicated connection, the protocols of which have already been referred to. The connection may depend on the amount of electronic transactions carried out by the terminal 2.

In the event of a reduced number of transactions, the dialed connection may be preferred, in which case the terminal 2 may use the public telephony network to be connected to the nearest PDPR 8, where a concentrating equipment called server remote access (SRA) may control multiple telephone lines, receiving and concentrating the transactions of several terminals 2. The connection may be carried out between a modem (modulator/demodulator) present in terminal 2 (that may carry out the conversion of the digital signals of the terminal into analog signals suitable for the transmission to telephone lines) and one of the SRA modems that may receive the analog signals and convert the signals back into the digital format, thus making it possible to transmit the data. The reverse procedure may take place when the response sent to the transaction is returned. The dialed connection may be temporary, since it may be established only while the transaction is being performed, and may be ended after the termination thereof.

Concerning the terminals 2 that carry out a high number of transactions, it may be convenient to use the dedicated connection, due to its much higher data communication speed, the terminal 2 being permanently connected to the PDPR 8 through terrestrial circuits, preferably but not necessarily implemented through copper cables or radio frequency circuits, generally implemented by pairs of radios operating at short distances or through satellite equipment (VSAT) without any distance restriction.

In its turn, the PDPR 8 may be connected through the TCP/IP communication protocol (already mentioned) to the central processing site (intermediate server 3/central processor 4) via digital communication circuits pertaining to public and/or private communication networks, e.g., the Internet. The Access Network may allow for the unchanged passage of messages in the WML format from the terminal to the Intermediate Server, and vice versa.

Other connection circuits between the PDPR 8 and the terminal(s) 2 may be used, as required or as desired.

In an embodiment of the present invention, the system may be implemented without using PDPRs 8. The PDPRs 8 may be considered as merely optional and even dispensable elements.

The first managing device, which may be in the form of an intermediate server 3, may be a computer connected to the communication network 7 and the central processing device 4 (to be described herein below). The first managing device may be controlled by a program that asynchronously manages the transactions in the WML format received from multiple terminals 2 and converts same into the ISO-8583 standard format before sending them to the central processor 4. While the response of the transaction is being emitted, the intermediate server 3 may receive messages from the central processor 4 in the ISO-8583 format and convert the messages into the WML format so that they can be sent back to the terminals. Besides the format conversion for the messages, the intermediate server 3 may store the application or layer 3 of all terminals, in the form of WML pages, acting as a repository or server of pages for the last version of the application available of each terminal 2 or group of the terminals 2, thus allowing for the implementation of an automatic centralized loading process of the applications in the terminals 2 associated with the communication network 7.

In one example embodiment of the present invention, an intermediate server 3 may be provided. The intermediate server 3 may present any architecture required or desirable. In another embodiment, the system of the present invention may be provided without the intermediate server 3. According to this latter embodiment, the remote terminals 2 may be directly connected to the central processing device 4.

The second managing device, which may be in the form of a central processor 4, may be a computer controlled by an OLTP (On Line Transaction Processing) monitor that assures the automation of the transaction, thus making it possible to undo same in the event of any trouble that may hinder its overall execution.

The central processor 4 may be connected to one or more external authorization mechanisms 5 and the intermediate server 3. The latter may be carried out through a local high speed connection.

When the transaction is being carried out, the central processor 4 may receive the transactions in the ISO-8583 format from the intermediate server 3. The central processor 4 may convert the transactions into an internal format that allows for the accomplishment of a procedure that pre-validates the message by analyzing specific alpha-numerical fields that are then used to determine the destination address of the transaction amongst the many external authorization mechanisms 5.

After the address is defined, the central processor 4 may determine the specific format set out for each authorization mechanism 5. The central processor 4 may carry out the relevant conversion of formats and complete the routing procedure by sending the transaction in the protocol specified for a particular authorization mechanism.

For every transaction, the central processor 4 may create and keep a storage area containing all the details of the transaction necessary to create the response to the origin terminal 2 based on the positive or negative authorization of the external authorization mechanism 5, besides a timer to assure that, in the event it does not respond to the transaction in a pre-determined time interval, a time expired message is sent back to the terminal 2, terminating the procedure.

The external authorization mechanism 5 may include a set of information that may be consulted every time an electronic transaction is initiated, and the access thereto may be related to the electronic card that is being used, or when an electronic transaction is realized (i.e. bill payment, on-line reloading of cellular phone, whatever the payment is). This mechanism may authorize or withhold authorization for the transaction after consulting the information related to the consumer and/or the transaction.

In an example embodiment of the present invention, the external authorization mechanism may correspond to equipment and information of the system customer (that is, the credit card administrating company, the financial institution, the cellular phone operator company, etc.), which has the information for authorizing or withholding authorization for the electronic transaction execution.

In addition, it is also possible that the functions of said mechanism 5 be integral with the intermediate server 3 and/or the central processor 4. In this case, the information of this equipment authorizes or withholds authorization for the electronic transaction execution, and the authorization mechanism 5 is considered internal.

In an example embodiment of the present invention, an electronic transaction may not be performed without an authorization, thus requiring the presence of a transaction authorization mechanism, external or internal to the present system.

In an example embodiment of the present invention, the system may provide only one controlling and processing device that embodies the functionalities of the intermediate server, the central processor and the external authorization mechanisms.

The operations of the system of the present invention for performing a transaction are listed below and they correspond to a procedure for sending instructions from the intermediate server 3 and/or the central processor 4 (that can be generally named as managing device) to a remote terminal 2:
A. Capture of a transaction in a terminal 2 by inputting data, e.g., via a magnetic card, bar code reader, CMC-7 code reader, keyboard or combination of multiple devices controlled by the program of the terminal that reads the data of the several devices and store same locally;
B. Organization of the captured data together with the information related to the identification of the terminal 2 and the communication network 7 to which it belongs in only one WML message;
C. Encapsulation of the message in accordance with a communication protocol so that it can be sent to the communication network 7;
D. Reception and routing of the transaction through the communication network 7, thus assuring its integrity through the several communication mechanisms and circuits that comprise same, to the intermediate server 3;
E. Concentration and disencapsulation of the transaction and retrieval of the original messages sent by the terminal 2. Then, the intermediate server 3 may reorganize the messages in the ISO-8583 standard format that can be interpreted by the central processor 4 and may send the message through a local connection (8);
F. Analysis of the validity and integrity of the data and extraction of the information required for the formatting and routing of the authorization message in accordance with an ISO-8583 standard that was previously defined for every external authorization mechanism 5, that may be carried out in the central processor 4;
G. Response to the transaction (that may be positive or negative) returned by the external authorization mechanism 5 to the central processor 4, which may identify the terminal 2 where the transaction was originated and may direct the response to the intermediate server 3 and then through the communication network 7;
H. Reception and decoding of the response sent by terminal 2 where the transaction was originated, that may also send same to its printer, monitor or both, according to the type of transaction.

In an example embodiment of the present invention, it may be possible to remotely update the terminals 2 without requiring the presence of employees on site and without the need to either interrupt or seriously compromise its capacity to effect the transactions while the update is being carried out, which are drawbacks found in the systems for performing financial transactions of the state of the art. As already mentioned, updates are carried out in a relatively constant way, as a way to implement new functionality into the system. For example, so that a purchase can be divided in a variable number of installments, it may be desirable to insert protecting mechanisms against violations, e.g., the need to type the 4 last digits of the card number, etc.

To remotely update the terminals 2 an automatic procedure may be provided for loading and/or updating the application (or third layer) of the command sub-routine of the terminal 2. The procedure of sending instructions already mentioned may be provided on several terminals 2 of the system 1 in an automatic way, transparent to the users. It is thus possible to quickly implement new tasks or even corrections and/or upgrades of the applications already implemented in the field. This procedure, being new and inventive, is also an object of the present invention.

This procedure may be thoroughly implemented between the terminals 2 and the intermediate server 3 by using the communication network to transfer the applications that are stored therein.

Generally, the procedure of sending instructions may include the following:
(i) capturing data for a transaction on the terminal 2, and organization and local storage thereof;
(ii) routing of the transaction to the managing device (intermediate server 3 and/or central processor 4);
(iii) information analysis on the managing device (intermediate server 3 and/or central processor 4);
(iv) response of the managing device (intermediate server 3 and/or central processor 4) to the terminal 2 confirming or not the transaction;
In addition, (i) may include the communication between the terminal 2 and the managing device (intermediate server 3 and/or central processor 4), and it may selectively send to the terminal 2 at least a second instruction to the operation.

As already mentioned, the command sub-routines of the terminal 2 may be divided into three layers, in order to make it possible to provide an automatic procedure. Both the first and second layers may be fixed and common to all the terminals 2, and can be previously installed in the plant or in the equipment logistic center before its distribution across the field. It is possible for the terminal to perform its first operation as soon as it is connected to the system, and, therefore, they are named generally as first instruction to terminal 2 operation.

The third layer or application of the terminal 2 deals with the implementation of the tasks and the specific functionality of every terminal 2 and is subdivided into several pages of WML architecture instructions (containing a series of instructions and commands for the terminal 2 to perform) which are concatenated through WML hyperlinks. Every WML page can be changed irrespective of the others, provided that there are no breaks or errors in the hyperlink chain, thus making it possible to implement a modular and progressive loading and/or updating procedure. In its turn, the intermediate server 3 may act as a WML page server for all the terminals 2 of the system 1, operating as a central repository of the applications.

In an example embodiment of the present invention, the initialization of the loading/updating procedure is affected by asynchronous events to the intermediate server 3 originated in, and by demand of, the terminals 2, thus naturally distributing the load moment of the several terminals 2 in time, which will be explained later.

The loading/updating procedure may be initiated when the terminals are activated and search for the initial page of the application in their local memory. When the terminal is activated for the first time (such as when it has just been installed in the field and therefore the application has not been installed yet), the non-availability of the initial page in the local memory may make it necessary to initiate same together with the intermediate server 3 a communication procedure that ends only when the missing page is loaded, which is stored on terminal memory. In one embodiment, only an initial page, which corresponds to a functions menu that can be executed by terminal 2, may be loaded. This first page or menu may have hyperlinks so that the terminal can call/load the correspondent pages to all operations that it can perform. For example, a terminal 2 can have the operations of making possible bills payment, pre-paid cellular phones reloading and cash availability, or performing shopping transactions by debit or credit, among other possibilities.

Due to these features, the application or third layer can be generally named as second operation instruction.

Basically, in (i) of the procedure of communication, the terminal 2 may verify whether its memory stores the corresponding page(s) to a specific transaction that it will execute, determined from captured card and/or input data. In case the pages are in the memory, terminal 2 may perform the transaction naturally, such as discussed in A to H above.

However, in case the page(s) is (are) not in the memory, terminal 2 may send a message to the intermediate server 3 through the communication network 7 asking for the missing page to be sent, and it may always send back the last version of the page available in its repository of pages. The same procedure may be used for the other pages, thus making it necessary to load all the pages of the application in the local memory of the terminal 2 as they are needed for the application.

In this manner, when an electronic transaction starts on terminal 2, two situations can occur:
1. If the page is already present in the memory of the terminal 2, it may be used, thus preventing new accesses to the intermediate server 3, assuring a better performance for the application and reducing the traffic generated by the terminals in the communication network 7.
2. When the terminal needs a page and does not have it, or if the validity date of the latter is expired (to be explained herein below), it may send a message to the intermediate server 3 asking if there is a new version of the page in question. If the answer is positive, this new page may be sent by the intermediate server 3 and loaded by the terminal 2 to replace the existing one. If there is not a new page, the terminal may abort the loading procedure and may renew the validity of the local page for a further period.

Then (ii) of the procedure starts forward.

The concept of page validity period may be used to make it possible to automatically update the pages already loaded in the local memory. As already briefly described herein above, terminal 2 may always use the local page while the page is within the validity period.

The validity period of the pages can be varied and configured by a manager of the system, thus allowing the adoption of multiple loading strategies for the existing terminals 2. Usually, in case the pages have a bigger validity period, the implantation of modifications in all terminals 2 will be slower and vice-versa.

The loading/updating procedure disclosed herein makes it possible to fully load a new terminal 2 from a zeroed position and that changes and/or new functionality can be transferred to all terminals 2 in an automatic and transparent way.

As already mentioned, the pages of the third layer may have a validity period and may be loaded by the terminal when replaced. However, the first and second layers may be installed in the terminals 2 while they are manufactured, and such information, at least in theory, never need to be loaded. In one embodiment, the many pages belonging to the application may have distinct validity periods so that they are loaded gradually, and, therefore, the amount of information transmitted by the intermediate server 3 in each loading operation is low, so they do not interfere with the information related to the electronic transactions.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawing, specification, and following claims.

1. A system for performing electronic business, comprising:
at least one terminal provided with at least one management program, the at least one management program including at least one first instruction for operation of the at least one terminal, the at least one terminal operatively associated with at least one managing device,
wherein the at least one managing device selectively sends towards the at least one terminal at least one second operating instruction.

2. The system according to claim 1, wherein the at least one managing device selectively sends towards the at least one terminal a plurality of second operating instructions in the form of instructions pages concatenated with one another.

3. The system according to claim 2, wherein the instructions pages sent by the terminal have a validity period.

4. The system according to claim 1, wherein the at least one management program of the at least one terminal includes operating instructions in the form of concatenated command sub-routines.

5. The system according to claim 4, wherein the command sub-routines have at least one application layer that includes a plurality of concatenated instructions pages for the operation of the at least one terminal.

6. The system according to claim 2, wherein the pages have a Wireless Markup Language (WML) architecture and are concatenated through WML hyperlinks.

7. The system according to claim 1, wherein the at least one terminal and the at least one managing device are coupled via a communication network.

8. The system according to claim 1, wherein the at least one managing device is an intermediate server.

9. The system according to claim 1, wherein the at least one managing device is a central processor.

10. The system according to claim 1, wherein:
the at least one managing device includes an intermediate server and a central processor,
the intermediate server manages transactions received from the at least one terminal, and
the central processor carries out a pre-validation and routing of the transactions.

11. The system according to claim 10, further comprising:
at least one external authorization mechanism associated with the central processor, the mechanism including a set of information which is consulted every time a transaction is attempted.

12. The system according to claim 1, wherein the operating instructions of the at least one terminal facilitates a capture of information from a transaction and a coding of the information in a suitable format for transmission to the managing device.

13. The system according to claim 1, wherein the at least one terminal includes a plurality of terminals, the plurality associated with a regional presence site (PDPR) that concentrates information before sending the information to the at least one managing device.

14. A method for sending instructions, executed by a system for performing electronic transactions, the system comprising at least one terminal having at least one management program formed by at least one first instruction for operation of the at least one terminal and operatively coupled to at least one managing device, the method comprising:
capturing data for a transaction on the at least one terminal, the data being organized and locally stored;
routing the transaction towards the at least one managing device;
analyzing information on the at least one managing device;
responding by the managing device to the at least one terminal, the response one of confirming and withholding confirmation for the transaction;
wherein the at least one terminal and the at least one managing device are communicatively coupled, the method further comprising:
selectively sending, by the at least one managing device towards the at least one terminal, at least one second instruction for operation of the at least one terminal.

15. The method according to claim 14, wherein the at least one second instruction includes a plurality of second operating instructions that are sent as instruction pages concatenated to each other.

16. The method according to claim 15, wherein the instruction pages have a validity period.

17. A system for performing electronic business, comprising:
at least one terminal provided with at least one management program, the at least one management program including at least one first instruction for operation of the at least one terminal;
at least one managing device, the at least one terminal operatively associated with the at least one managing device; and
at least one external authorization mechanism,
wherein the at least one managing device selectively transmits towards the at least one terminal a plurality of second operating instructions in the form of instructions pages concatenated with one another, the instructions pages having a validity period, having a Wireless Markup Language (WML) architecture, and being concatenated through WML hyperlinks,
wherein operations performed by the at least one terminal are remotely updated via the selective transmission of the plurality of second operating instructions,
wherein the at least one first instruction is in the form of concatenated command sub-routines, the command sub-routines having at least one application layer that includes a plurality of concatenated instructions pages for the operation of the at least one terminal,
wherein the at least one first instruction facilitates a capture of information from a transaction and a coding of the information in a suitable format for transmission to the at least one managing device, the information being organized and locally stored,
wherein the at least one terminal and the at least one managing device are coupled via a communication network,
wherein the at least one managing device includes an intermediate server that manages transactions received from the at least one terminal, and includes a central processor that carries out a pre-validation and routing of the transactions, the central processor analyzing information that is on the at least one managing device,
wherein the pre-validation is at least partially based on the analysis,
wherein the at least one external authorization mechanism is associated with the central processor, and includes a set of information which is consulted every time a transaction is attempted, and
wherein the at least one terminal includes a plurality terminals associated with a regional presence site (PDPR) that concentrates information before sending the information to the at least one managing device.
